(19) United States
(12) Patent Application Publication
(10) Pub. No.: US 2010/0137750 A1
(43) Pub. Date: Jun. 3, 2010

(54) Therapeutic Deep Pressure Aid For Disabled Persons

(76) Inventor: Terrand B. Grall, Plymouth, WI (US)

Correspondence Address: BOYLE FREDRICKSON S.C., 840 North Plankinton Avenue, MILWAUKEE, WI, 53203, US

(21) Appl. No.: 12/391,050

(22) Filed: Feb. 23, 2009

Related U.S. Application Data
(60) Provisional application No. 61/030,277, filed on Feb. 21, 2008.

(51) Int. Cl. A61H 7/00

(52) U.S. Cl. 601/1

(57) ABSTRACT

A therapeutic aid providing deep pressure or tactile stimulation to a person, comprising a central portion extending longitudinally the length of a person, with laterally extending flexible fingers extending from the central portion, displaced along either side of the longitudinal axis of the central portion. The flexible fingers provide multiple segments to wrap a person within the central portion and the fingers, to cocoon a person and provide sensory comfort. Individual fingers provide independent segments to individualize pressure and placement of the tactile stimulation. The present invention is engageable with other therapeutic aids such as positioning aids, wheelchairs, lift chairs, floor sitters and the like. The present invention is contemplated to act as a therapeutic aid and be calming or comforting for people with autism or other cognitive disabilities. The present invention may be made of lightweight, mold and bacteria-resistant material and be easily folded and or taken apart for storage.

### CROSS-REFERENCE TO RELATED APPLICATIONS

This application claims the benefit of U.S. provisional application 61/030,277 filed Feb. 21, 2008 and hereby incorporated by reference.

### STATEMENT REGARDING FEDERALLY SPONSORED RESEARCH OR DEVELOPMENT

---

### BACKGROUND OF THE INVENTION

The present invention relates to therapy for persons diagnosed with a sensory integration dysfunction, autism, or similar disorders. Some disabilities, particularly neurodevelopment disorders, such as autism, make it difficult for a person to organize sensory input and interpret environmental stimuli which can lead to extreme stress and anxiety. Autistic individuals, for example, tend to react very differently to sensory stimulation than do people without autism, particularly touch or tactile stimulation.

Yet, individuals have considerable variation with regards to the degree to which the sensory system is affected. Some individuals exhibit oversensitivity, while others have under-reactivity, to touch, movement, sights, or sounds.

Certain kinds of sensory stimulation can help the neurological system to normalize and adjust the accuracy of the body's sensory perception. Generally speaking, deep touch pressure is the type of surface pressure that is exerted in most types of firm touching, holding, hugging, or other physical contact. Current therapy includes very firm hugs, wrapping a person tightly in a blanket, or squeezing a person between two gymnastics mats or other cushioned mats. While these techniques have helped somewhat, these measures have not been fully effective.

### SUMMARY OF THE INVENTION

The present invention provides a therapeutic aid for sensory, or tactile stimulation, by individually affecting both the amount of pressure and particular location, to be most effective to an individual. This invention allows specificity with regard to the particular parts of the body upon which the person desires the pressure and the particular level of pressure desired. In other words, the invention allows for almost unlimited adjustability of the amount and location of pressure on the disabled person as is deemed necessary by a licensed practitioner.

Specifically, the present invention provides a therapeutic aid provide tactile stimulation to a person, having a central portion wherein the central portion extends longitudinally the length of a person, with laterally extending flexible fingers extending from the central portion. The flexible fingers provide multiple segments to wrap a person within the central portion and the fingers, to cocoon a person and provide sensory comfort. In at least one embodiment of the present invention, there are five separate segments. It is thus an object of the invention to selectively apply pressure to particular areas of a person's body.

In at least one embodiment of the present invention, the therapeutic aid allows a therapist, or other person, to apply different amounts of intense, cushioned, wrap-around pressure to up to six separate areas of the body.

In at least one embodiment of the present invention, the central portion has one or more disengagement or break away points to facilitate use in seated or other body positions besides that of lying. In at least one embodiment of the present invention, the therapeutic aid interlocks with other therapy aids, for example with positioning aids such as incline wedges, elevation wedges, prone-positioning aids, and the like. In yet another embodiment, the therapeutic aid also includes a horseshoe shaped head and neck pillow that provides additional head control for supine, prone, and side-lying positions.

In at least one embodiment of the present invention, the laterally extending flexible fingers also have position-adjustable fasteners, such as straps, that allow the fingers to wrap tighter or looser around the user. It is thus an object of the invention to provide variable pressure to a person, depending on what level of pressure is most effective for that particular individual.

The present invention also includes adjustable shoulder straps that may extend longitudinally or radially from the head of the central portion, to allow downward pressure to be applied, particularly on a person's shoulders and wrap around the upper chest.

These particular advantages may apply to only some embodiments falling within the claims and thus do not define the scope of the invention.

### BRIEF DESCRIPTION OF THE FIGURES

FIG. 1 is a top plan view of the present invention;

FIG. 2 is an isometric view of the present invention;

FIG. 3A is a partial plan view from the underside of the present invention;

FIG. 3B is the same partial plan view as FIG. 3A, with a perspective from the top of the present invention;

FIG. 4 is a side plan schematic diagram of the flexible fingers wrapping around the central portion.

FIG. 5 is an isometric view of the present invention in use for a supine-lying user; and

FIG. 6 is a side plan view of the invention in use with a wheelchair.

### DETAILED DESCRIPTION OF THE PREFERRED EMBODIMENT

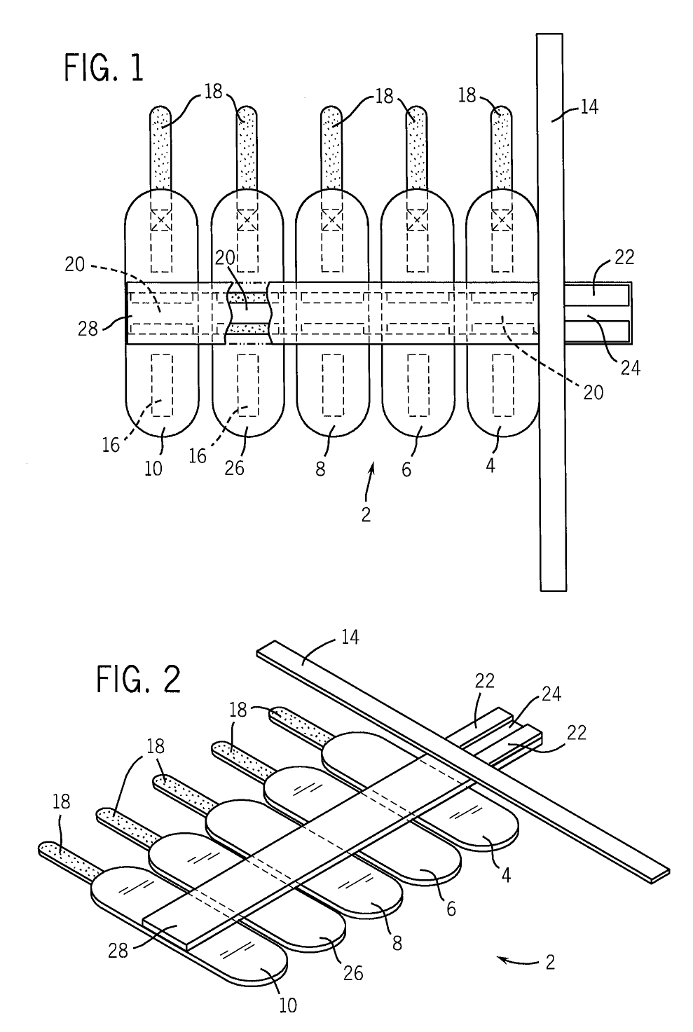

Referring to FIGS. 1 and 2, a therapeutic aid 2 comprises a central portion 28, having a head 24 and a foot 20, wherein the central portion 28 extends along a longitudinal axis. This central full length part of the device acts as a core off of which all of the wraps, straps, pillows and other pressure application and positioning parts of the product can be semi-permanently and or permanently attached. The central portion 28 is substantially the length of a person, but may be different general sizes from roughly three feet to six feet in length. The aid 2 can be manufactured for use with children or adults.

The therapeutic aid 2, generally, is made of a mold-resistant, water resistant material. The material is institutional quality water resistant foams that exceed cal 117 fire codes and are treated at the manufacturing stage with antibacterial and mold retardants. It is made of foam or batting, with a vinyl, polyester, leather or plastic cover. Preferably, the therapeutic aid 2 is made of lightweight material such as a crosslink polyethylene or polyurethane foam core. The outer casing for the foam is made of anti-bacterial, anti-fungal, water resistant, breathable nylon that is made specifically for health care applications and is easy to wipe clean.

The central portion 28 is rectangularly shaped. For a therapeutic aid 2 that is made for toddlers, the central portion width is approximately nine inches. A therapeutic aid 2 that fits adults has an approximate width of twenty-one inches. Varying sizes of the therapeutic aid 2 have widths that correspond proportionally to the shoulder width of the person (for a toddler, child, teenager, adult female, adult male, for example). The central portion 28 varies in size depending on the user and is manufactured in different sizes, from dimensions of approximately forty inches long and approximately nine inches wide, to dimensions of approximately eighty-four inches long with a width of approximately twenty-one inches.

Laterally extending flexible fingers 4, 6, 8, 10, and 12, extend from the central portion 28, or are engageable with the central portion 28 via connection points 20. The fingers 4, 6, 8, 10, and 12, are attached either along the longitudinal axis sides of the central portion, or engageable with the underside of the central portion 28 connected with Velcro-style hook and loop fasteners. Alternatively, the therapeutic aid 2 may be constructed as a general central portion 28 with displaced fingers 4, 6, 8, 10, 12 extending along the longitudinal axis sides of the central portion 28, wherein the therapeutic aid 2 is made of substantially one piece of material.

The fingers 4, 6, 8, 10, 12 are substantially rectangular, extending outwardly and are approximately double the width of the central portion 28. Therefore, for a toddler-sized therapeutic aid 2, an individual finger extends approximately nine inches, to allow it to fold over the central portion 28 to provide tactile stimulation. Likewise, for an adult-sized therapeutic aid 2, an individual finger has a length of approximately twenty-one inches. As such, the fingers' length is proportional to the overall size of the central portion.

The width of the fingers 4, 6, 8, 10, 12 may be approximately one-third to one-half the length of the finger. However, the width of the finger may be variable depending on manufacturing need. The displacement spaces between fingers 4, 6, 8, 10, 12 may be as little as three inches, but as much as twenty inches, depending on the overall size of the therapeutic aid 2. The displacement space allows the aid 2 to be folded, molded for sitting or incline resting or other positioning of a person to maximize therapeutic stimulation. However, it is also necessary for spacing to prevent bunching and pinching between or with the individual fingers.

The fingers 4, 6, 8, 10, 12 wrap around the central portion 28 in order to provide up to six separately and independent wrapping segments, to provide tactile stimulation. These individual, adjustable body wraps allow for a range of pressure to vary across the body. Each wrapping segment provides tactile stimulation to particular sections of the body, such as the upper chest, the abdomen, the pelvic region, the upper leg and the lower leg. Depending on the size of the person, these general areas may be different, but with substantially the same effect.

The wrapping segments provide differing circumferences depending on what the overall therapeutic aid 2 is sized for. For example, a wrapping segment that fits a toddler, who is twenty-nine inches to approximately forty inches, would have a wrapping segment with an approximate wrapping circumference of twenty-eight inches. A large adult may have an approximate wrapping segment circumference of sixty-five inches. Overall, the width of the central portion 28 comprises approximately a third of the overall circumference, with opposing laterally extending fingers 4, 6, 10, 12, each extending outwardly and having an approximate length equal to, or slightly greater than, the width of the central portion 18.

The fingers 4, 6, 10, 12 are made of a similar foam or batting to the central portion 28. The cover is made of a vinyl, polyester, leather, or plastic or composite thereof. The central portion 28 and the laterally extending flexible fingers 4, 6, 8, 10 and 12, are made of a weighted material, such as dense foam or batting, to provide deep pressure therapy to an individual during use.

A fastener 18 extends outwardly from each laterally extending finger, wherein the opposing finger has a receiving fastener, such as Velcro® hook and loop style straps and receiving tape, snaps, or clips. In the preferred embodiment, the fastener 18 is a position-adjustable strap so that the wrapped segment can be modified to fit the individual's size and personal ideal pressure applied. In other words, the fastener 18 can be adjusted to provide more or less pressure via minimizing or maximizing the overall circumference of the wrapping segment.

The user is able to personally release the fasteners 18, whether hook and loop straps, or another type of fastener. This is true whether the user's hands are outside the individual wrapping segments or folded alongside the body and wrapped inside. Alternatively, a therapist or other caregiver may also release the fasteners 18.

A pair of shoulder straps 14 attach to a belt # and will extend proximal from the head 24 of the central portion 28 to provide downward pressure on a person's shoulders. The shoulder straps 14 are cushioned and comprised of the same material as the central portion 28 and the fingers 4, 6, 10, 12. The shoulder straps 14 are long enough to wrap over a person's shoulders and extend downwardly to provide pressure on the shoulders and upper chest. The shoulder straps 14 are thinner than the fingers 4, such that the width is no more than the width of a person's individual shoulder. This prevents bunching and increases overall comfort. The straps 14 may have Velcro-style hook and loop fasteners affixed along the central length of the straps 14. A chest belt (not shown) may wrap around a person's chest and the straps 14 loop around the belt and connect back onto the straps themselves. This provides the application of downward pressure. The belt (not shown) may be affixed to the central portion 28 between the displaced fingers, either at the chest level or the waist level of the person. The belt need not be permanently affixed, but may simply wrap around the underside of the central portion and extend over the top of the central portion along a lateral axis.

A neck rest (not shown) may also provide comforting pressure and extend perpendicularly from the longitudinal axis of the central portion 28, proximal to the head of the central portion 28.

The fasteners 18 are used to complete the wrapping segment by providing a connection point for each extending opposing finger to engage. Also, the fastener 18 helps provide the proper pressure to apply to the user. Since the fastener 18 is adjustable, a therapist or other caregiver can increase or decrease the tightness of the wrapping segment to provide the most ideal pressure for that individual user.

In the preferred embodiment, the fasteners 18 extend substantially the length of the finger 4 such that when the fastener 18 is affixed to the opposing finger's receiving fastener, the fastener strap itself provides a comfort pressure when the wrapping segment is used.

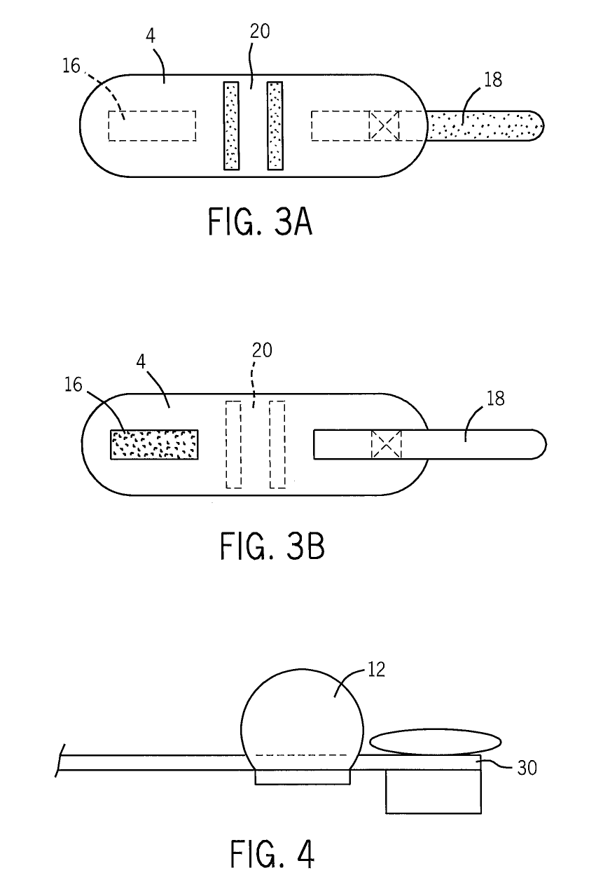

Referring to FIG. 3A, which shows a laterally extending flexible finger 4 removed from the central portion 28 (not shown). In the preferred embodiment, the flexible finger is a rectangle, approximately sixty-five inches in length, with convexly curved ends. This length is for an adult therapeutic aid 2. Each finger is approximately 12-18 inches in width. Along the central region of the finger 4, connectors 20, such as hook and loop strips, are affixed to the topside of the finger 4. These connectors 20 affix by a receiving connector, a receiving or female hook and loop strip for example, which is affixed to the underside of the central portion 28. This arrangement allows a person to rest comfortably on the length of the central portion 28, like a mattress, and the finger 4 to wrap entirely around in a lateral direction. That is, the finger wraps horizontally across a user's back, underneath the central portion, and each end of the finger encircles the person, creating a pressure from the outside into the person. This pressure calms people with autism and some cognitive disorders. In essence, the person is swaddled by the individual fingers.

A connector 20 is provided to attach the central portion 28 to the flexible finger 4. This removability of the different elements allows the therapeutic aid 2 to be easily washed in parts, as well as allowing break-away segments for multiple uses such as for wheelchair use, positioning packages such as supine laying positioning packages, incline wedges and the like. Also, the modifiable nature of the therapeutic aid 2 allows the aid 2 to be used for small children and for adults.

A position-adjustable fastener 18 is affixed to the flexible finger 4, extending length-wise along substantially one side of the flexible finger 4, to provide additional pressure around a person. In the preferred embodiment, this fastener 18 is a strap with a Velcro-style hook and loop tape affixed to it. In the preferred embodiment, the opposing end of the finger 4 has a receiving fastener 16, which extends length-wise along it. The fastener could also be a tongue and buckle connector (like a seatbelt) with an adjuster, or a belt buckle or any similar position-adjustable fastener. The adjuster may be affixed to the fastener strap, or part of the tongue or buckle connector.

Referring to FIG. 3B, the receiving fastener 16 provides a connector for the position-adjustable fastener 18, to provide individualized pressure to a person. In employing a fastener that is position-adjustable, the fingers embrace the user more completely and at the ideal pressure for maximum therapy. Thus, as the finger extends outwardly and laterally from underneath a person, such that the person lies in the middle of the finger, resting on a perpendicularly oriented central portion. The finger is then encircled about the person, providing a embrace-like comfort to the person.

As shown in FIG. 4, the flexible finger 12 wraps around the central portion 28. The fingers 12 create individualized wrapping segments, displaced along the longitudinal axis of the central portion 28. The displacement between individual fingers allows a tighter swaddle, and with minimal pinching or bunching.

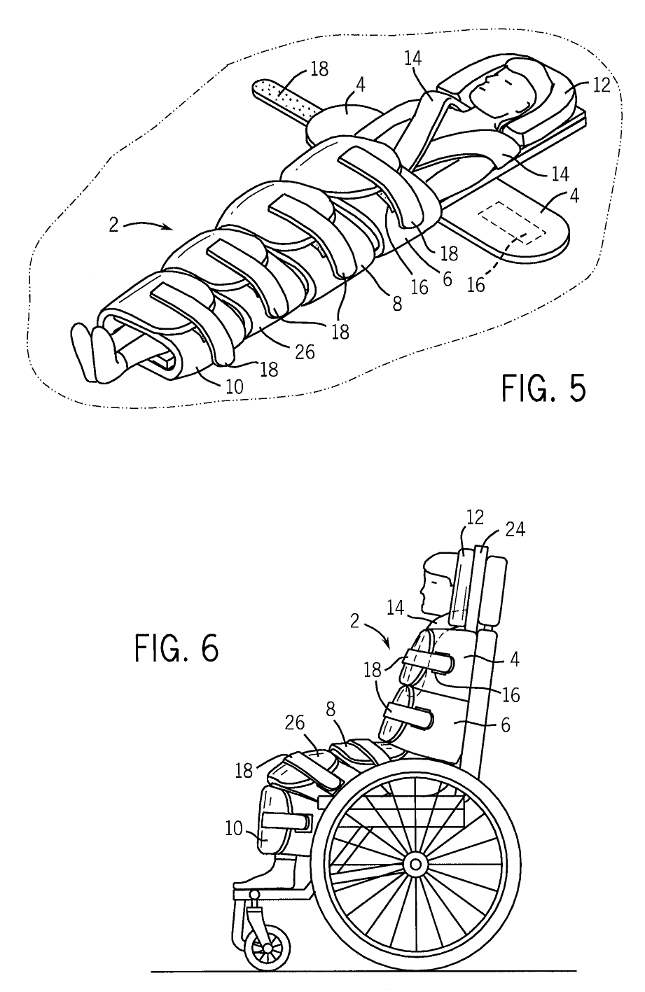

FIG. 5 shows the therapeutic aid 2 in use for a person in a supine position. A horseshoe-shaped head piece, or pillow 12, secures a person's head in a comfortable manner, while also providing additional safe head control for lying in a supine position. This also may provide additional comfort and stimulation by aiding in the overall “cocoon” effect for a person. The pillow 12 also provides additional head control for supine, prone, and side-lying safety. The shoulder straps 14 provide downward pressure and then a chest-level finger 4 embraces the person, over the shoulder straps.

A person lies on the longitudinally extending central portion 28. Shoulder straps 14 provide a downward pressure for a person. In FIG. 5, the person has four laterally extending fingers 6, 8, 10, 12 creating individual wrapping segments along the person's abdomen, thigh, knee, and lower leg areas. The chest segment, comprising a laterally extending fastener 4, is open also to show the shoulder straps 14 in use. Both the downward pressure provided by the shoulder straps 14 and a chest lateral finger 4 can be used simultaneously for tactile stimulation.

FIG. 6 illustrates the therapeutic aid 2 in use for a person in a wheelchair. The central portion having break away segments to allow flexibility enables comfort when used in this manner. The head piece 12 surrounds a person's head and can be used as a neck-roll, resting on a person's shoulders with the ends of the “U”-shape extending from the frontal end of the person's shoulders and the curved section of the head piece 12 wrapping around the back of a person's neck. Alternatively, the head piece 12, or pillow, can be used vertically so that the curved section of the head piece 12 rests on the top of a person's head with the arms of the U-shaped head piece extending downwardly on either side, preventing excessive head nodding by the person. The head 24 of the central portion 28 is visible, providing additional pressure and comfort to a person. The therapeutic aid 2 with one or more disengagement or break away points facilitates use in seated or other body positions besides that of lying.

The aid 2 is portable and can be folded in half for easy storage. There may be indents horizontally along the underside of the central portion, which may make folding and storage easier. Likewise, the displacements between the fingers allow space to provide folding areas within the central portion.

It will be understood that the present invention is not limited strictly to a certain number of segments or particular lengths or sizes. It is specifically intended that the present invention not be limited to the embodiments and illustrations contained herein, but include modified forms of those embodiments including portions of the embodiments and combinations of elements of different embodiments as come within the scope of the following claims.

I claim:

1. A therapeutic aid to provide tactile stimulation to a person, the therapeutic aid comprising:
a central portion flexibly continuous along a longitudinal axis, sized to extend substantially along the length of the person;
having a plurality of flexible fingers extending substantially perpendicular from the central portion, displaced along the longitudinal axis of the central portion, wherein each finger is positioned to have an opposing finger, allowing the opposing fingers to wrap around the central portion creating a wrapping segment around the person; and
wherein each finger has a fastener to hold the wrapping segment around the person, providing adjustable amounts of pressure.

2. A therapeutic aid according to claim 1, wherein the central portion and the fingers are made of a weighted material, consisting of institutional quality water resistant foams that exceed cal 117 fire codes.

3. A therapeutic aid according to claim 1, wherein the fastener is position-adjustable to provide varying amounts of pressure.

4. A therapeutic aid according to claim 1, wherein the central portion having a head and a foot; and further including a pair of shoulder straps attached proximal to the head of the central portion, embracing a person's neck area and providing downward pressure on a person's upper chest.

5. A therapeutic aid according to claim 1, wherein the central portion and fingers provide five separate wrapping segments for individualized pressure points.

6. A therapeutic aid according to claim 1, wherein the central portion further having individual sections, such that the aid is bendable to minimize overlap of the fingers, allowing use of the aid while a person is in a seated position.

7. A therapeutic aid according to claim 1, wherein the central portion is engageable with incline wedges.

8. A therapeutic aid according to claim 1, wherein the central portion is engageable with a wheelchair.

9. A therapeutic aid according to claim 1, wherein the position-adjustable fastener is a hook and barb fastener.

10. A therapeutic aid according to claim 1, wherein the central portion having a head and a foot; and further including a horseshoe-shaped pillow engageable with the head of the central portion.

11. A therapeutic blanket for tactile stimulation, comprising:
a central portion flexibly continuous along a longitudinal axis, having a head and a foot, a left side and a right side;
having a plurality of flexible fingers affixed along the left and right sides of the central portion, extending substantially perpendicular from the central portion, displaced along the longitudinal axis of the central portion, wherein each finger is positioned to have an opposing finger, allowing the opposing fingers to enclose the central portion creating a wrapping segment around the person; and
wherein each finger has a fastener to hold the wrapping segment around the person, providing adjustable amounts of pressure.
a pair of shoulder straps attached proximal to the head of the central portion, embracing a person's neck area and providing downward pressure on a person's upper chest; and
wherein each finger and the pair of flexible straps each having a position-adjustable fastener.
